(19) United States
(12) Patent Application Publication
(10) Pub. No.: US 2019/0173289 A1
(43) Pub. Date: Jun. 6, 2019

(54) POWER CONTROL APPARATUS AND POWER CONTROL METHOD

(71) Applicant: SONY CORPORATION, TOKYO (JP)

(72) Inventors: DAISUKE KAWAMOTO, KANAGAWA (JP); TADASHI MORITA, TOKYO (JP); MARIO TOKORO, TOKYO (JP)

(21) Appl. No.: 16/313,934

(22) PCT Filed: May 26, 2017
(86) PCT No.: PCT/JP2017/019662

§ 371 Date: Dec. 28, 2018

(30) Foreign Application Priority Data
Jul. 8, 2016 (JP) 2016-135912

(51) Int. Cl. H02J 4/00; H02J 1/00; H02J 3/32

(52) U.S. Cl. CPC H02J 4/00; H02J 3/32; H02J 1/00

(57) ABSTRACT

[Object] To provide a power control apparatus capable of using a converter at the optimum conversion efficiency when transferring power between nodes through a power line.

[Solution] There is provided a power control apparatus including: an acquisition section configured to acquire information from a node on a power reception side which receives power through a power line, the information pertaining to a characteristic of a conversion device that converts voltage between the power line and a storage battery on the power reception side; and a setting section configured to use the information acquired by the acquisition section and a characteristic of a conversion device that converts voltage between the power line and a storage battery on a power transmission side to set voltage of the power line.

### TECHNICAL FIELD

The present disclosure relates a power control apparatus and a power control method.

### BACKGROUND ART

An uninterruptible power source apparatus has been known that includes a storage battery, and can hereby keep on supplying power from the storage battery to an apparatus connected thereto for a predetermined time without causing power interruptions even when power from an input power source is cut off. Technology has been proposed in which such a power source apparatus is extended to units of customers (which will also be referred to as nodes) to supply surplus power to other customers when an abnormality occurs in supplying power due to power interruption, in the case where a storage battery has little remaining power, or the like (see Patent Literature 1, Patent Literature 2, and the like).

### CITATION LIST

### Patent Literature

Patent Literature 1: JP 2015-056976A

Patent Literature 2: WO 2015/072304

### DISCLOSURE OF INVENTION

### Technical Problem

Each node includes a converter (DC-DC converter or AC-DC converter) that converts the voltage between a power line and a storage battery. The conversion efficiency of the converter varies in accordance with the input and output voltage ratio. Meanwhile, the voltage of the storage battery varies in accordance with the capacity. Therefore, if the voltage of the power line is fixed at a predetermined voltage value, it is not possible to use the converter at the optimum conversion efficiency when transferring power through the power line.

Accordingly, the present disclosure proposes a novel and improved power control apparatus and power control method capable of using a converter at the optimum conversion efficiency when transferring power between nodes through a power line.

### Solution to Problem

According to the present disclosure, there is provided a power control apparatus including: an acquisition section configured to acquire information from a node on a power reception side which receives power through a power line, the information pertaining to a characteristic of a conversion device that converts voltage between the power line and a storage battery on the power reception side; and a setting section configured to use the information acquired by the acquisition section and a characteristic of a conversion device that converts voltage between the power line and a storage battery on a power transmission side to set voltage of the power line.

In addition, according to the present disclosure, there is provided a power control apparatus including: an acquisition section configured to acquire information from a node on a power transmission side which transmits power through a power line, the information pertaining to a characteristic of a conversion device that converts voltage between the power line and a storage battery on the power transmission side; and a selection section configured to use the information acquired by the acquisition section and a characteristic of a conversion device that converts voltage between the power line and a storage battery on a power transmission side to select a power transmission source.

In addition, according to the present disclosure, there is provided a power control method including: acquiring information from a node on a power reception side which receives power through a power line, the information pertaining to a characteristic of a conversion device that converts voltage between the power line and a storage battery on the power reception side; and using the acquired information and a characteristic of a conversion device that converts voltage between the power line and a storage battery on a power transmission side to set voltage of the power line.

In addition, according to the present disclosure, there is provided a power control method including: acquiring information from a node on a power transmission side which transmits power through a power line, the information pertaining to a characteristic of a conversion device that converts voltage between the power line and a storage battery on the power transmission side; and using the acquired information and a characteristic of a conversion device that converts voltage between the power line and a storage battery on a power transmission side to select a power transmission source.

### Advantageous Effects of Invention

According to the present disclosure as described above, it is possible to provide a novel and improved power control apparatus and power control method capable of using a converter at the optimum conversion efficiency when transferring power between nodes through a power line.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating a configuration example of a power supply system 1 according to an embodiment of the present disclosure.

FIG. 2 is an explanatory diagram describing a configuration example of a node 10.

FIG. 3 is an explanatory diagram illustrating an example of an efficiency curve of a DCDC converter 120.

FIG. 4 is an explanatory diagram illustrating an example of an efficiency curve of the DCDC converter 120 with respect to voltage of a bus line 30.

FIG. 5 is an explanatory diagram illustrating efficiency curves of nodes 10a and 10b illustrated in FIG. 1, and an average of the two efficiency curves.

FIG. 6 is an explanatory diagram illustrating efficiency curves of the nodes 10a, 10b, 10c, and 10d illustrated in FIG. 1, and an average of the four efficiency curves.

FIG. 7 is an explanatory diagram illustrating an efficiency curve.

FIG. 8 is an explanatory diagram illustrating that power is transferred in a case where nodes are hierarchically disposed.

FIG. 9 is an explanatory diagram illustrating a case where power is transferred over clusters.

FIG. 10 is an explanatory diagram illustrating an efficiency curve.

FIG. 11 is a sequence diagram describing an operation example of a node of the power supply system 1 according to the embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.
1. Embodiment of the Present Disclosure
1.1. Overview
1.2. Configuration Example and Operation Example
2. Conclusion

### <1. Embodiment of the Present Disclosure>

### [1.1. Overview]

Before an embodiment of the present disclosure is described in detail, the overview of the embodiment of the present disclosure will be described.

As described above, the technology is disclosed for a power supply system in which, between nodes each including a power generation apparatus such as a solar power generation apparatus that uses natural energy and renewable energy to generate power and a battery that stores the power generated by the power generation apparatus, the power stored in the batteries is interchanged (see Patent Literature 1 and the like).

Technology is also disclosed for a system in which power is autonomously interchanged between the respective nodes in such a power supply system (see Patent Literature 2 and the like). Autonomously interchanging power between nodes individually optimizes the respective batteries.

Each node includes a converter (DC-DC converter or AC-DC converter) that converts the voltage between a power line and a storage battery. The conversion efficiency of the converter varies in accordance with the input and output voltage ratio. Meanwhile, the voltage of the storage battery varies in accordance with the capacity. Therefore, if the voltage of the power line is fixed at a predetermined voltage value, it is not possible to use the converter at the optimum conversion efficiency when transferring power through the power line.

Accordingly, in view of what has been described above, the present disclosers have assiduously studied technology capable of using a converter at the optimum conversion efficiency when transferring power through a power line. As a result, the present disclosers have devised technology capable of using a converter at the optimum conversion efficiency as described below by setting the voltage of a power line with the conversion efficiency of the converter taken into consideration when transferring power.

The above describes the overview of an embodiment of the present disclosure. Next, the embodiment of the present disclosure will be described in detail.

### [1.2. Configuration Example and Operation Example]

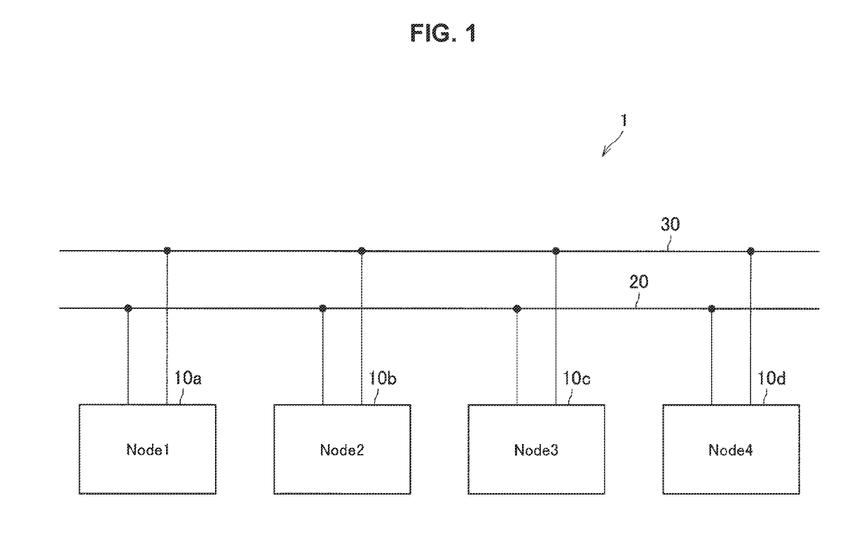

First, a configuration example of the power supply system according to an embodiment of the present disclosure will be described. FIG. 1 is an explanatory diagram illustrating a configuration example of a power supply system 1 according to an embodiment of the present disclosure. The following uses FIG. 1 to describe a configuration example of the power supply system 1 according to an embodiment of the present disclosure.

The power supply system 1 illustrated in FIG. 1 has nodes 10a to 10d (which will be referred to simply as nodes 10 in some cases) connected through a communication line 20 and a bus line 30. The nodes 10a to 10d are power consumption units. Each node is one power generation and power consumption unit including, for example, a home, a company, a school, a hospital, a city office, and the like. The configurations of the nodes 10a to 10d will be described below. However, each of the nodes 10a to 10d includes a storage battery that stores power, and a converter that converts the voltage between the storage battery and the bus line. The following describes that the bus line 30 is an example of a power line and allows direct current to flow, but the bus line 30 may also allow alternating current to flow. That is, the converter provided to each node is either a DC-DC converter or an AC-DC converter.

In the case where a certain node (which will be described as the node 10a below) needs power, the power supply system 1 illustrated in FIG. 1 transmits a power request from that node 10a to another node through the communication line 20. The other node that receives the power request returns a supply response to the node 10a through the communication line 20 if the other node can accept the power request. This supply response can include, for example, information of a suppliable power amount, time slot, price, point, or the like.

The node 10a that receives the supply response from another node selects a node from which the node 10a is supplied with power on the basis of the content of the supply response. Then, the node 10a transmits, through the communication line 20, a selection response to the selected node. Here, it is assumed that the node 10a selects a node 10b as a node from which the node 10a is supplied with power.

When the node 10b receives the selection response transmitted from the node 10a, the node 10b acquires the control right of the bus line 30 and sets a predetermined value as the voltage of the bus line 30. Here, the node 10b sets the predetermined value as the voltage of the bus line 30 as described below on the basis of the characteristics of the converter of the node 10b that is a power transmission side of power and the characteristics of the converter of the node 10a that is a power reception side.

The node 10b sets the voltage of the bus line 30 on the basis of the characteristics of the converter of the node 10b that is a power transmission side of power and the characteristics of the converter of the node 10a that is a power reception side, thereby making it possible to use the converter of each node at the optimum conversion efficiency. A method for setting the voltage of the bus line 30 will be described in detail.

The above uses FIG. 1 to describe a configuration example of the power supply system 1 according to an embodiment of the present disclosure. Next, a configuration example of the node 10 will be described.

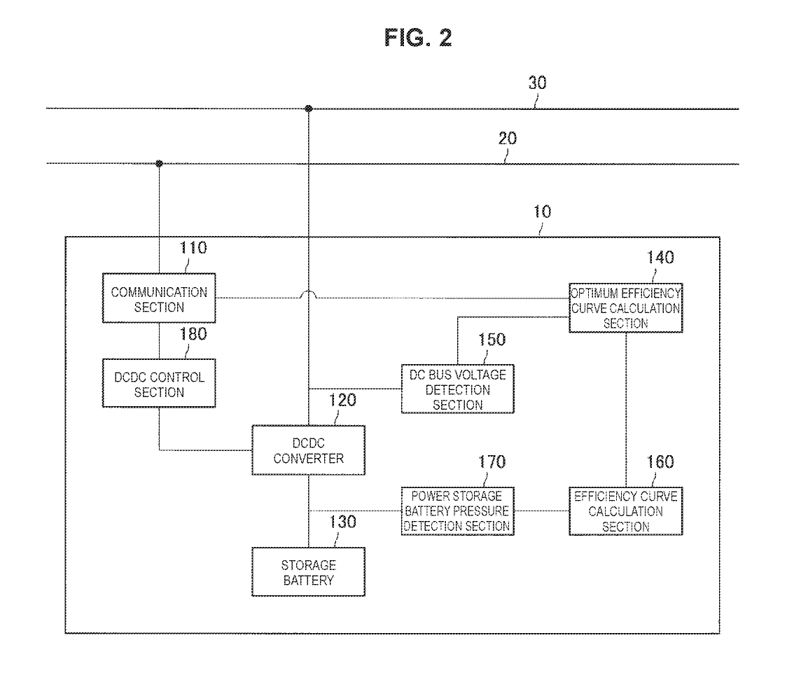

FIG. 2 is an explanatory diagram describing a configuration example of the node 10. The following uses FIG. 2 to describe a configuration example of the node 10 according to an embodiment of the present disclosure.

As illustrated in FIG. 2, the node 10 according to an embodiment of the present disclosure includes a communication section 110, a DCDC converter 120, a storage battery 130, an optimum efficiency curve calculation section 140, a DC bus voltage detection section 150, an efficiency curve calculation section 160, a storage battery voltage detection section 170, and a DCDC control section 180.

The communication section 110 executes communication processing with another node through the communication line 20. The communication section 110 allows various kinds of information to be communicated with another node. For example, the communication section 110 transmits a power transmission request to another node through the communication line 20. This transmission of a power transmission request may be broadcast transmission with no destination designated, or multicast transmission with a plurality of nodes designated. In addition, for example, the communication section 110 receives a power transmission request transmitted from another node through the communication line 20. If it is possible to transmit power, the communication section 110 returns a supply response to that node. In addition, for example, the communication section 110 receives a supply response transmitted from another node through the communication line 20. In the case where the communication section 110 accepts power reception from that node, the communication section 110 returns a selection response to that node.

When the communication section 110 transmits a power transmission request, the communication section 110 transmits an efficiency curve of the own node described below along with the power transmission request. In addition, when the communication section 110 receives a supply response, the communication section 110 receives an efficiency curve of a node that transmits the supply response along with the supply response.

The DCDC converter 120 is provided between the bus line 30 and the storage battery 130, and converts the direct current voltage between the bus line 30 and the storage battery 130. In addition, the DCDC converter 120 sets the voltage of the bus line 30. The DCDC converter 120 sets the voltage of the bus line 30 in the case where the own node has acquired the control right of the bus line 30. The DCDC converter 120 sets the voltage of the bus line 30 as a voltage value set by the DCDC control section 180 described below.

The storage battery 130 is, for example, a lithium ion secondary battery, a sodium-sulfur battery, or other secondary batteries. The storage battery 130 stores power generated by a power generation apparatus that is not illustrated, but uses sunlight, solar heat, wind power, or the like to generate power.

The optimum efficiency curve calculation section 140 calculates the optimum efficiency curve from an efficiency curve of the storage battery 130 of the own node and an efficiency curve of the storage battery of another node. In addition, when the bus line 30 transfers power between other nodes, the optimum efficiency curve calculation section 140 calculates, in the case where the own node participates to transfer power, the optimum efficiency curve from an efficiency curve of the storage battery 130 of the own node and an efficiency curve of the storage battery of another node. A method for the optimum efficiency curve calculation section 140 to calculate an efficiency curve will be described in detail below.

The DC bus voltage detection section 150 detects the voltage of the bus line 30. By detecting the voltage of the bus line 30, the DC bus voltage detection section 150 knows whether or not the bus line 30 transfers power between other nodes. The DC bus voltage detection section 150 sends information of the voltage of the bus line 30 to the optimum efficiency curve calculation section 140.

The efficiency curve calculation section 160 calculates an efficiency curve with respect to the voltage of the bus line 30 on the basis of the voltage of the storage battery 130 detected by the storage battery voltage detection section 170. Information of the efficiency curve of the own node calculated by the efficiency curve calculation section 160 is used by the optimum efficiency curve calculation section 140 to calculate an efficiency curve.

The storage battery voltage detection section 170 detects the voltage of the storage battery 130 which varies in accordance with the capacity. The storage battery voltage detection section 170 sends information of the voltage of the storage battery 130 to the efficiency curve calculation section 160.

On the basis of the efficiency curve calculated by the optimum efficiency curve calculation section 140, the DCDC control section 180 controls the DCDC converter 120 such that the voltage of the bus line 30 becomes the voltage that can be used by the DCDC converter 120 the most efficiently.

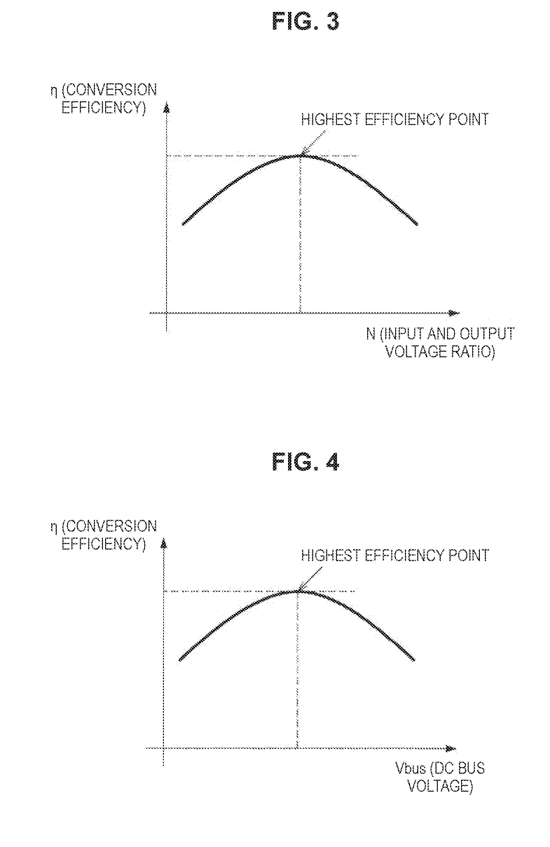

FIG. 3 is an explanatory diagram illustrating an example of an efficiency curve of the DCDC converter 120. The DCDC converter 120 capable of setting input voltage and output voltage shows conversion efficiency η that varies in accordance with an input and output voltage ratio N as illustrated in FIG. 3. Then, the DCDC converter 120 like that has a characteristic in which the conversion efficiency is the highest in the case where the input and output voltage ratio N has a certain value.

FIG. 4 is an explanatory diagram illustrating an example of an efficiency curve of the DCDC converter 120 with respect to the voltage of the bus line 30. An efficiency curve of the DCDC converter 120 with respect to the voltage of the bus line 30 can be calculated by multiplying the efficiency curve illustrated in FIG. 3 by voltage Vbat of the storage battery 130 at that time. That is, the efficiency curve calculation section 160 multiplies the efficiency curve illustrated in FIG. 3 by a voltage value detected by the storage battery voltage detection section 170, thereby calculating the efficiency curve as illustrated in FIG. 4. That is, the efficiency curve calculation section 160 calculates an efficiency curve of the DCDC converter 120 with respect to the voltage of the bus line 30 in accordance with V_{bus}=N×V_{bat}.

The efficiency curve calculated in this way can be different for each node. That is, the voltage of the bus line 30 at which the conversion efficiency of the DCDC converter 120 is the most favorable can be different for each node. Thus, the optimum efficiency curve calculation section 140 uses efficiency curves of a plurality of nodes including the own node to calculate the optimum efficiency curve. The optimum efficiency curve calculation section 140 calculates, for example, the average of a plurality of efficiency curves. Then, the DCDC control section 180 sets the voltage Vbus at which the average value reaches the maximum value as the voltage of the bus line 30, thereby making it possible to set the voltage at which the efficiency is favorable for not only the power transmission side, but also the power reception side.

Specific examples for calculating the optimum efficiency curve and setting the voltage value of the bus line 30 will be described. An example of the case will be demonstrated where power is supplied from the node 10b to the node 10a in the power supply system 1 illustrated in FIG. 1.

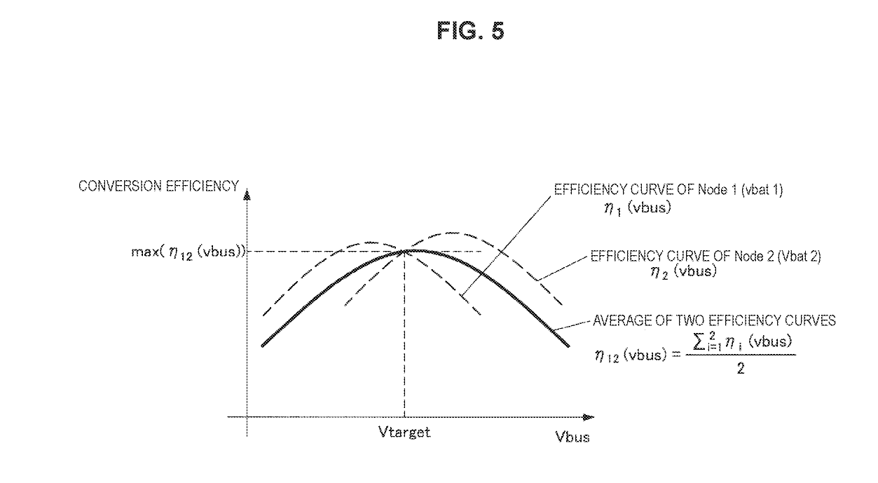

FIG. 5 is an explanatory diagram illustrating efficiency curves of two nodes, for example, the nodes 10a and 10b illustrated in FIG. 1, and the average of the two efficiency curves.

The optimum efficiency curve calculation section 140 of the node 10b calculates an average η₇₂(V_{bus}) of an efficiency curve η₁(V_{bus}) of the DCDC converter 120 of the node 10a acquired when a power transmission request is received from the node 10a, and an efficiency curve η₂(V_{bus}) of the DCDC converter 120 of the own node on the basis of the following formula 1.

$$\begin{matrix}[ Math . 1 ] & \\ {η}_{12} = \frac{{\sum }_{i = 1}^{2} {η}_{i} ( Vbus )}{2} & ( formula 1 )\end{matrix}$$

The DCDC control section 180 sets, as the voltage of the bus line 30, voltage Vtarget at which the conversion efficiency is the highest in the average η₁₂(V_{bus}) of efficiency curves calculated in this way by the optimum efficiency curve calculation section 140. The DCDC control section 180 sets the voltage Vtarget as the voltage of the bus line 30, thereby allowing the node 10b to interchange power to the node 10a at the voltage at which the efficiency is the most favorable for both the own node and the node 10a to which power is transmitted.

Other specific examples for calculating the optimum efficiency curve and setting the voltage value of the bus line 30 will be described. Examples of the cases will be demonstrated where power is supplied from the node 10b to the node 10a, and power is supplied from the node 10c to the node 10d in the power supply system 1 illustrated in FIG. 1.

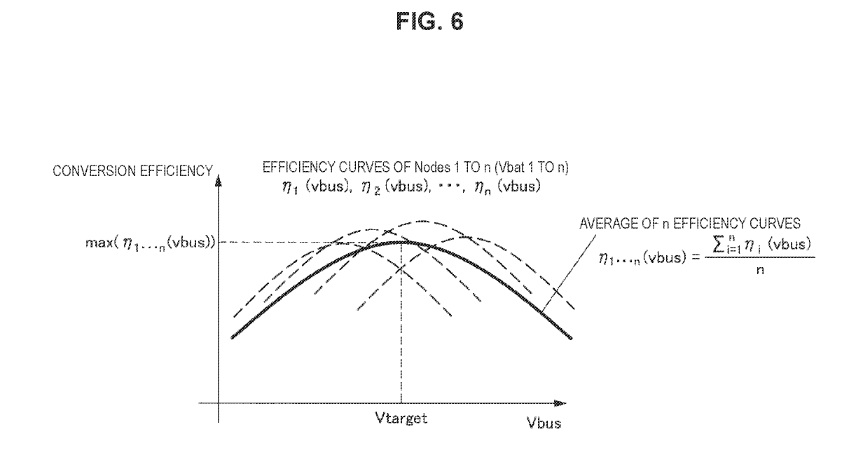

FIG. 6 is an explanatory diagram illustrating efficiency curves of four nodes, for example, the nodes 10a, 10b, 10c, and 10d illustrated in FIG. 1, and the average of the four efficiency curves.

The case will be considered where power is further interchanged from the node 10c to the node 10d in the case where power is interchanged from the node 10b to the node 10a. The optimum efficiency curve calculation section 140 of the node 10b calculates an average η_{1 . . . 4}(V_{bus}) of the efficiency curve η₁(V_{bus}) of the DCDC converter 120 of the node 10a, the efficiency curve η₂(V_{bus}) of the DCDC converter 120 of the own node, an efficiency curve η₃(V_{bus}) of the DCDC converter 120 of the node 10c, and an efficiency curve η₄(V_{bus}) of the DCDC converter 120 of the node 10d on the basis of the following formula 2.

$$\begin{matrix}[ Math . 2 ] & \\ {η}_{1 … 4} = \frac{{\sum }_{i = 1}^{4} {η}_{i} ( Vbus )}{4} & ( formula 2 )\end{matrix}$$

The DCDC control section 180 sets, as the voltage of the bus line 30, voltage Vtarget at which the conversion efficiency is the highest in the average η_{1 . . . 4}(V_{bus}) of efficiency curves calculated in this way by the optimum efficiency curve calculation section 140. The DCDC control section 180 sets the voltage Vtarget as the voltage of the bus line 30, thereby allowing the node 10b to set the voltage at which the efficiency is the most favorable for all the nodes that interchange power.

In the case where supply responses are transmitted from a plurality of nodes, a node to which power is interchanged may select a node having the efficiency curve in which the conversion efficiency is the most favorable as a source from which power is interchanged.

The case will be considered where the node 10b transmits a power supply and the nodes 10a and 10c returns supply responses to the node 10b in the power supply system 1 illustrated in FIG. 1. The nodes 10a and 10c each return an efficiency curve of the own node to the node 10b along with the supply response.

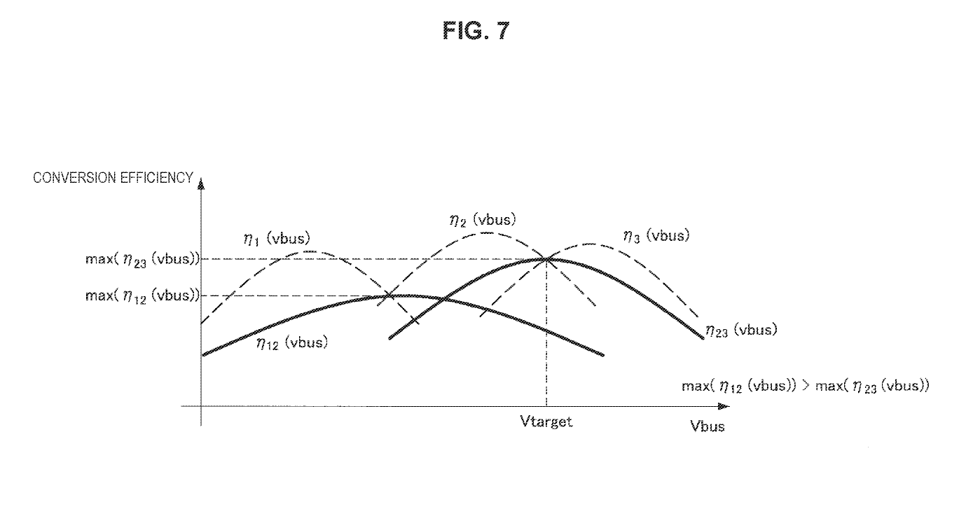

The optimum efficiency curve calculation section 140 of the node 10b calculates the average of an efficiency curve of the own node and an efficiency curve of each of the nodes 10a and 10c. FIG. 7 is an explanatory diagram illustrating efficiency curves of the nodes 10a, 10b, and 10c, an average η₁₂(V_{bus}) of efficiency curves of the nodes 10a and 10b, and an average η₂₃(V_{bus}) of efficiency curves of the nodes 10b and 10c.

If the averages η₁₂(V_{bus}) and η₂₃(V_{bus}) illustrated in FIG. 7 are compared, it is η₂₃(V_{bus}) that has higher maximum conversion efficiency. Thus, if the node 10b selects the node 10c as a source from which power is interchanged, the node 10b can receive power at higher efficiency. In this case, for example, the optimum efficiency curve calculation section 140 may select a node having the efficiency curve in which the conversion efficiency is the most favorable as a source from which power is interchanged.

The examples shown so far have described the case where all the nodes are disposed in the same layer, but the respective nodes may also be hierarchically disposed.

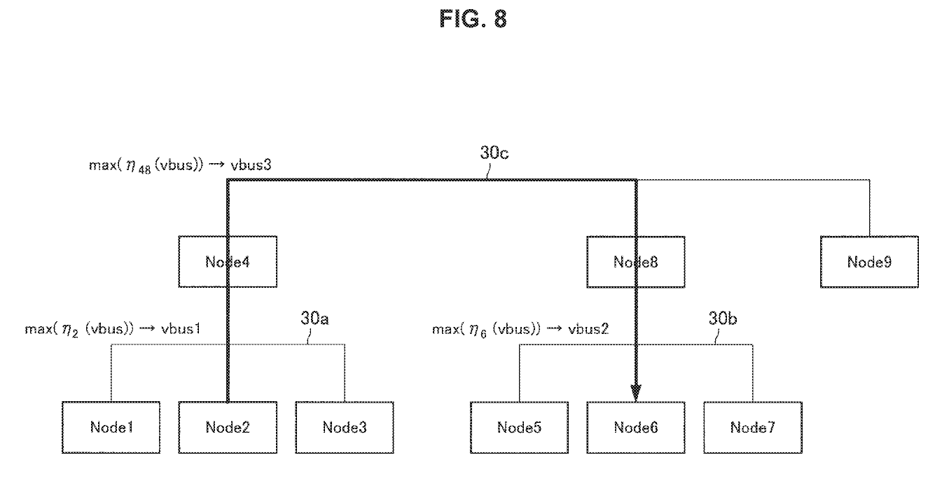

FIG. 8 is an explanatory diagram illustrating that power is transferred in the case where nodes are hierarchically disposed. In the example illustrated in FIG. 8, nodes 1 to 3 and nodes 5 to 7 are disposed in a lower layer, a node 4 is disposed in a higher layer of the nodes 1 to 3, a node 8 is disposed in a higher layer of the nodes 5 to 7, and the nodes 4, 8, and 9 are disposed in the same layer. The nodes 1 to 4 are connected to a bus line 30a, the nodes 5 to 8 are connected to a bus line 30b, and the nodes 4, 8, and 9 are connected to a bus line 30c. Note that FIG. 8 omits a communication line to which each node is connected.

The case will be considered where, for example, power is supplied to the node 6 from the node 2 through the nodes 4 and 8 in the example illustrated in FIG. 8. In this case, the node 2 decides voltage vbus1 of the bus line 30a from the efficiency curve η₂(V_{bus}) of the DCDC converter 120 of the own node. In addition, the node 4 uses the efficiency curve η₄(V_{bus}) of the DCDC converter 120 of the own node and an efficiency curve η₈(V_{bus}) of the DCDC converter 120 of the node 8 to decide voltage vbus3. For example, the node 4 sets, as the voltage vbus3 of the bus line 30c, the voltage at which the efficiency has the maximum value in an average η₄₈(V_{bus}) of η₄(V_{bus}) and η₈(V_{bus}). In addition, the node 6 decides voltage vbus2 of the bus line 30b from the efficiency curve η₆(V_{bus}) of the DCDC converter 120 of the own node.

By deciding the voltage of the bus lines in this way, the nodes 2, 4, and 6 can cause all the nodes through which power is transferred to operate at the most favorable efficiency.

It is also possible to group a plurality of nodes into one cluster. In the case where a plurality of nodes are grouped into one cluster, it is also possible to cause one node to serve as a hub to transfer power over clusters. Even in this case, it is possible to set the voltage of a bus line provided to each cluster on the basis of an efficiency curve of the DCDC converter provided to each node.

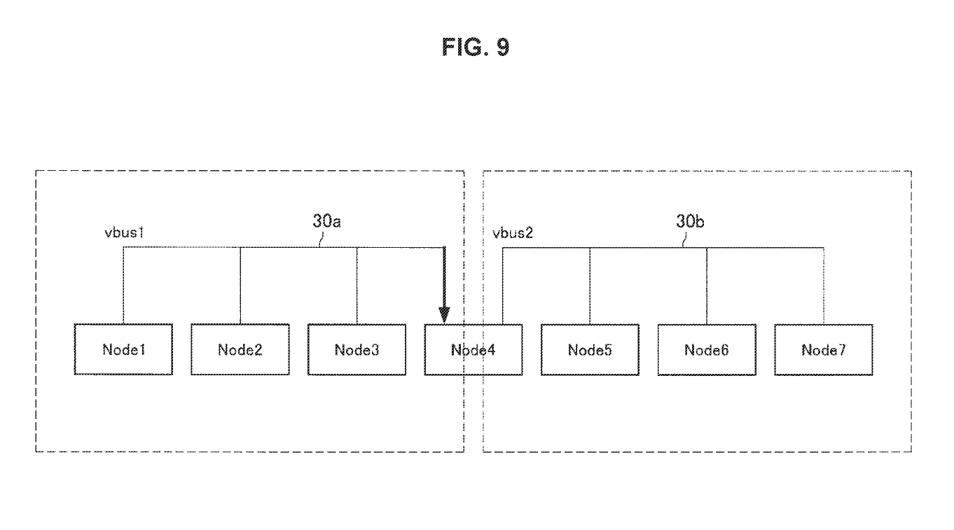

FIG. 9 is an explanatory diagram illustrating the case where a plurality of nodes are grouped into one cluster, and power is transferred over clusters. FIG. 9 illustrates the state in which the nodes 1 to 4 are grouped into one cluster, and the nodes 4 to 7 are grouped into one cluster. The nodes 1 to 4 are connected to the bus line 30a, and the nodes 4 to 7 are connected to the bus line 30b. That is, the node 4 is connected to both of the bus lines 30a and 30b.

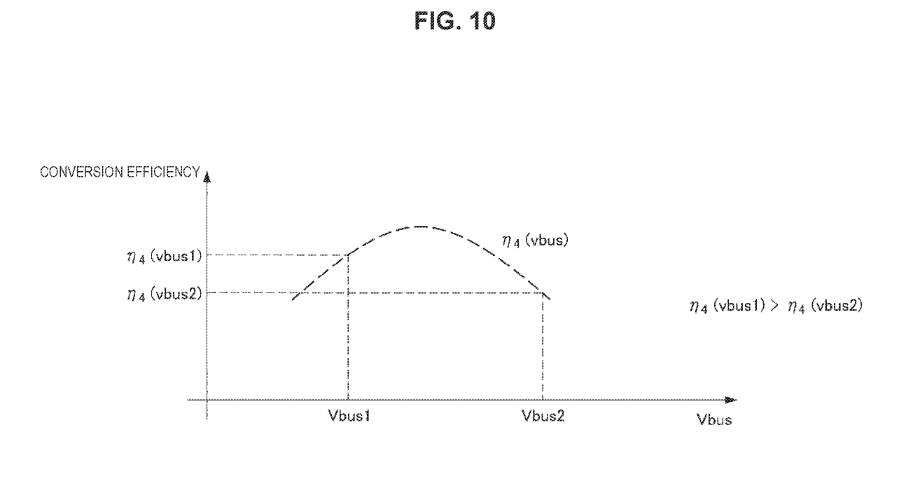

In the state in which the voltage V_{bus1} and the voltage V_{bus2} are respectively applied to bus lines 30a and 30b, the node 4 computes efficiency η₄(V_{bus}) and efficiency η₄(V_{bus2}) for the bus lines 30a and 30b. Then, the node 4 makes a decision such that power is received from the bus line having more favorable efficiency. FIG. 10 is an explanatory diagram illustrating the efficiency curve θ₄(V_{bus}) of the node 4. From the graph of the efficiency curve η₄(V_{bus}) illustrated in FIG. 10, the efficiency at the time of the voltage V_{bus1} is higher than the efficiency at the time of the voltage V_{bus2}. Thus, the node 4 can perform such power interchange that power is received from the bus line 30 to which the voltage V_{bus1} is applied, or power is transmitted to the bus line 30.

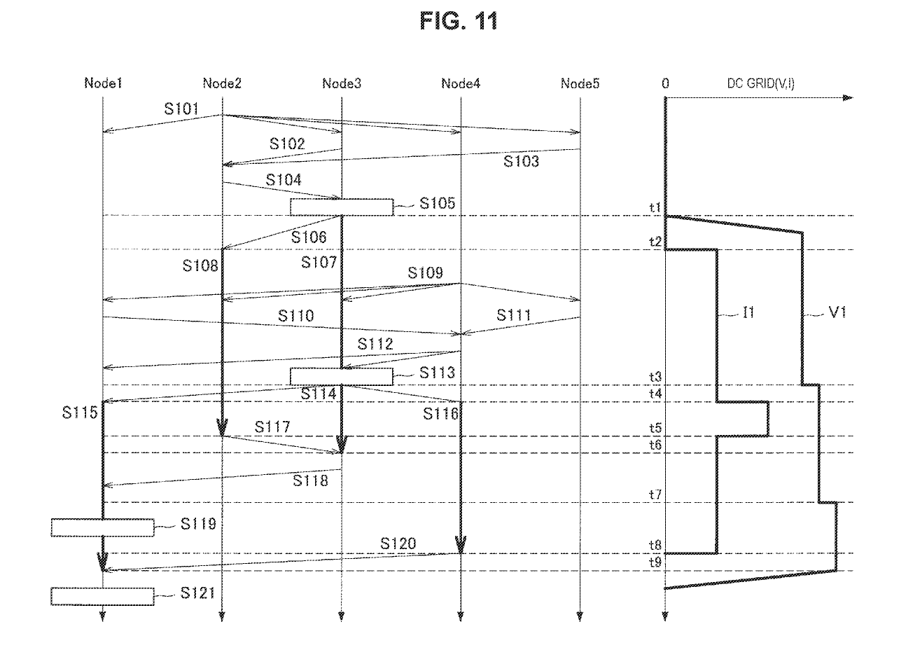

Next, an operation example of a node of the power supply system 1 according to an embodiment of the present disclosure will be described. FIG. 11 is a sequence diagram describing an operation example of a node of the power supply system 1 according to an embodiment of the present disclosure. What is illustrated in FIG. 11 is operation examples of the nodes 1 to 5 connected to the same bus line 30 and belonging to the same layer. In addition, FIG. 11 also illustrates change in the voltage and electric current of the bus line 30. The following uses FIG. 11 to describe an operation example of a node of the power supply system 1 according to an embodiment of the present disclosure.

First, the flow of the case where the node 2 wishes to receive power from another node will be described. The node 2 transmits power requests to all the other nodes (or some nodes) through the communication line 20 (step S101). These power requests include not only information such as a desired power amount, time, and price, but also information of an efficiency curve of the DCDC converter 120 of the node 2.

When another node receives a power request from the node 2, the other node determines whether to accept the power request. If it is possible to accept the power request, the other node transmits a supply response to the node 2. In the example illustrated in FIG. 11, the nodes 3 and 5 each transmits a supply response to the node 2 (steps S102 and S103). When the nodes 3 and 5 each transmits a supply response to the node 2, the nodes 3 and 5 each include not only information of a suppliable power amount, time, price and the like, but also information of an efficiency curve of the DCDC converter 120 of the own node.

When selecting a power supply source, the node 2 that receives the supply responses from the nodes 3 and 5 uses an efficiency curve of the DCDC converter 120 of each node and an efficiency curve of the DCDC converter 120 of the own node to select a node from which power can be efficiently received as a power supply source. In the example illustrated in FIG. 11, the node 2 selects the node 3 as a power supply source.

When the node 2 selects the node 3 as a power supply source, the node 2 transmits a selection response to the node 3 (step S104). When the node 3 receives a selection response from the node 2, the node 3 acquires the control right of the bus line 30 and sets the voltage of the bus line 30 from an efficiency curve of the DCDC converter 120 of the node 2 and an efficiency curve of the DCDC converter 120 of the own node (step S105). As described above, the node 3 takes the average of efficiency curves of two nodes, and sets the voltage at which the efficiency is the highest as the voltage of the bus line 30. When the node 3 sets the voltage of the bus line 30 at time tl, the voltage of the bus line 30 begins to gradually increase.

The node 3 notifies another node of the acquisition of the control right of the bus line 30, and then begins to transmit power to the node 2 through the bus line 30 (step S107). The node 2 begins to receive power from the node 3 at time t2 (step S108). When the time t2 comes, the electric current flowing through the bus line 30 increases.

Afterward, the flow of the case where the node 4 also wishes to receive power from another node will be described. The node 4 transmits power requests to all the other nodes (or some nodes) through the communication line 20 (step S109). These power requests include not only information such as a desired power amount, time, and price, but also information of an efficiency curve of the DCDC converter 120 of the node 4.

When another node receives a power request from the node 4, the other node determines whether to accept the power request. If it is possible to accept the power request, the other node transmits a supply response to the node 4. In the example illustrated in FIG. 11, the nodes 1 and 5 each transmits a supply response to the node 4 (steps S110 and S111). When the nodes 1 and 5 each transmits a supply response to the node 4, the nodes 1 and 5 each include not only information of a suppliable power amount, time, price and the like, but also information of an efficiency curve of the DCDC converter 120 of the own node.

When selecting a power supply source, the node 4 that receives the supply responses from the nodes 1 and 5 uses an efficiency curve of the DCDC converter 120 of each node and an efficiency curve of the DCDC converter 120 of the own node to select a node from which power can be efficiently received as a power supply source. In the example illustrated in FIG. 11, the node 4 selects the node 1 as a power supply source.

When the node 4 selects the node 1 as a power supply source, the node 4 transmits a selection response to the node 1 (step S112). In addition, the node 4 also transmits a selection response indicating that power is supplied from the node 1 to the node 3 that has acquired the control right of the bus line 30 (step S112).

The node 3 that has acquired the control right of the bus line 30 sets the voltage of the bus line 30 again on the basis of efficiency curves of the nodes 1 to 4 (step S113). As described above, the node 3 takes the average of efficiency curves of four nodes, and sets the voltage at which the efficiency is the highest as the voltage of the bus line 30. When the node 3 sets the voltage of the bus line 30 at time t3, the voltage of the bus line 30 further increases.

The node 3 transmits information of the voltage value of the bus line 30 to the nodes 1 and 4 (step S114). The node 1 begins to transmit power to the node 4 through the bus line 30 (step S115). The node 4 begins to receive power from the node 1 at time t4 (step S116). When the time t4 comes, the electric current flowing through the bus line 30 increases.

In this way, power is supplied from the node 3 to the node 2 and from the node 1 to the node 4 through the bus line 30.

Afterward, when power supply terminates from the node 3 to the node 2, the node 2 transmits a termination notification to the node 3 at time t5 (step S117). At the time t5, the amount of electric current flowing through the bus line 30 decreases. When the node 3 receives the termination notification from the node 2 at time t6, the node 3 causes the control right of the bus line 30 to transition to the node 1 that is transmitting power at that time (step S118).

The node 1 that has acquired the control right of the bus line 30 sets the voltage of the bus line 30 (step S119). The node 1 sets the voltage of the bus line 30 on the basis of an efficiency curve of the DCDC converter 120 of the node 4 and an efficiency curve of the DCDC converter 120 of the own node. As described above, the node 1 takes the average of efficiency curves of two nodes, and sets the voltage at which the efficiency is the highest as the voltage of the bus line 30. When the voltage of the bus line 30 is set at time t7 in the example of FIG. 11, the voltage of the bus line 30 further increases.

Afterward, when power supply terminates from the node 1 to the node 4, the node 4 transmits a termination notification to the node 1 at time t8 (step S120). At the time t8, the amount of electric current flowing through the bus line 30 decreases. At that time, no power is transferred through the bus line 30. Accordingly, the amount of electric current flowing through the bus line 30 is 0.

When the node 1 receives the termination notification from the node 4 at the time t8, the node 1 discards the control right of the bus line 30 at time t9 because no other power is transferred through the bus line 30 at the time t8 (step S121). When the node 1 discards the control right of the bus line 30, voltage applied to the bus line 30 decreases to 0.

By performing the above-described operation, each node of the power supply system 1 according to an embodiment of the present disclosure can set the voltage of the bus line with the conversion efficiency of the DCDC converter of the node taken into consideration when transferring power through the bus line 30. Each node sets the voltage of the bus line with the conversion efficiency of the DCDC converter taken into consideration, thereby allowing the converter to be used at the optimum conversion efficiency.

### <2. Conclusion>

According to an embodiment of the present disclosure as described above, there is provided a node that can, when power is transferred between nodes connected to a common bus line (power line), set the voltage of the bus line with the conversion efficiency of a converter provided to each node taken into consideration.

According to an embodiment of the present disclosure, there is provided a node that can, when power is transferred between nodes connected to a common bus line, select a power transmission source with the conversion efficiency of the converter of the own node taken into consideration.

Note that each node may set the voltage at which the conversion efficiency is the most favorable in a converter on a power reception side as the voltage of a bus line, or set the voltage at which the conversion efficiency is the most favorable in a converter on a power transmission side as the voltage of a bus line.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A power control apparatus including:

an acquisition section configured to acquire information from a node on a power reception side which receives power through a power line, the information pertaining to a characteristic of a conversion device that converts voltage between the power line and a storage battery on the power reception side; and

a setting section configured to use the information acquired by the acquisition section and a characteristic of a conversion device that converts voltage between the power line and a storage battery on a power transmission side to set voltage of the power line.

(2)

The power control apparatus according to (1), in which

the setting section sets, as the voltage of the power line, voltage at which an average value of conversion efficiency of each conversion device reaches a maximum value.

(3)

The power control apparatus according to (1), in which

the setting section sets, as the voltage of the power line, voltage at which conversion efficiency is most favorable in a conversion device on the power reception side.

(4)

The power control apparatus according to (1), in which

the setting section sets, as the voltage of the power line, voltage at which conversion efficiency is most favorable in a conversion device on the power transmission side.

(5)

The power control apparatus according to any of (1) to (4), in which

the conversion device is a DC-DC converter.

(6)

The power control apparatus according to any of (1) to (4), in which

the conversion device is an AC-DC converter.

(7)

The power control apparatus according to any of (1) to (6), in which

the power line is a bus line.

(8)

A power control apparatus including:

an acquisition section configured to acquire information from a node on a power transmission side which transmits power through a power line, the information pertaining to a characteristic of a conversion device that converts voltage between the power line and a storage battery on the power transmission side; and

a selection section configured to use the information acquired by the acquisition section and a characteristic of a conversion device that converts voltage between the power line and a storage battery on a power transmission side to select a power transmission source.

(9)

The power control apparatus according to (8), in which

the acquisition section acquires the information of a node that responds to a power transmission request of power, the information pertaining to the characteristic of the conversion device.

(10)

The power control apparatus according to (8) or (9), in which

the selection section selects, as a power transmission source, a node in which a maximum value of an average value of conversion efficiency in each conversion device becomes highest.

(11)

The power control apparatus according to any of (8) to (10), in which

the conversion device is a DC-DC converter.

(12)

The power control apparatus according to any of (8) to (10), in which

the conversion device is an AC-DC converter.

(13)

The power control apparatus according to any of (8) to (12), in which

the power line is a bus line.

(14)

A power control method including:

acquiring information from a node on a power reception side which receives power through a power line, the information pertaining to a characteristic of a conversion device that converts voltage between the power line and a storage battery on the power reception side; and

using the acquired information and a characteristic of a conversion device that converts voltage between the power line and a storage battery on a power transmission side to set voltage of the power line.

(15)

A power control method including:

acquiring information from a node on a power transmission side which transmits power through a power line, the information pertaining to a characteristic of a conversion device that converts voltage between the power line and a storage battery on the power transmission side; and

using the acquired information and a characteristic of a conversion device that converts voltage between the power line and a storage battery on a power transmission side to select a power transmission source.

### REFERENCE SIGNS LIST

1 power supply system
10 node
20 communication line
30 bus line

1. A power control apparatus comprising:
an acquisition section configured to acquire information from a node on a power reception side which receives power through a power line, the information pertaining to a characteristic of a conversion device that converts voltage between the power line and a storage battery on the power reception side; and
a setting section configured to use the information acquired by the acquisition section and a characteristic of a conversion device that converts voltage between the power line and a storage battery on a power transmission side to set voltage of the power line.

2. The power control apparatus according to claim 1, wherein
the setting section sets, as the voltage of the power line, voltage at which an average value of conversion efficiency of each conversion device reaches a maximum value.

3. The power control apparatus according to claim 1, wherein
the setting section sets, as the voltage of the power line, voltage at which conversion efficiency is most favorable in a conversion device on the power reception side.

4. The power control apparatus according to claim 1, wherein
the setting section sets, as the voltage of the power line, voltage at which conversion efficiency is most favorable in a conversion device on the power transmission side.

5. The power control apparatus according to claim 1, wherein
the conversion device is a DC-DC converter.

6. The power control apparatus according to claim 1, wherein
the conversion device is an AC-DC converter.

7. The power control apparatus according to claim 1, wherein
the power line is a bus line.

8. A power control apparatus comprising:
an acquisition section configured to acquire information from a node on a power transmission side which transmits power through a power line, the information pertaining to a characteristic of a conversion device that converts voltage between the power line and a storage battery on the power transmission side; and
a selection section configured to use the information acquired by the acquisition section and a characteristic of a conversion device that converts voltage between the power line and a storage battery on a power transmission side to select a power transmission source.

9. The power control apparatus according to claim 8, wherein
the acquisition section acquires the information of a node that responds to a power transmission request of power, the information pertaining to the characteristic of the conversion device.

10. The power control apparatus according to claim 8, wherein
the selection section selects, as a power transmission source, a node in which a maximum value of an average value of conversion efficiency in each conversion device becomes highest.

11. The power control apparatus according to claim 8, wherein
the conversion device is a DC-DC converter.

12. The power control apparatus according to claim 8, wherein
the conversion device is an AC-DC converter.

13. The power control apparatus according to claim 8, wherein
the power line is a bus line.

14. A power control method comprising:
acquiring information from a node on a power reception side which receives power through a power line, the information pertaining to a characteristic of a conversion device that converts voltage between the power line and a storage battery on the power reception side; and
using the acquired information and a characteristic of a conversion device that converts voltage between the power line and a storage battery on a power transmission side to set voltage of the power line.

15. A power control method comprising:
acquiring information from a node on a power transmission side which transmits power through a power line, the information pertaining to a characteristic of a conversion device that converts voltage between the power line and a storage battery on the power transmission side; and
using the acquired information and a characteristic of a conversion device that converts voltage between the power line and a storage battery on a power transmission side to select a power transmission source.
